(19) United States
(12) Patent Application Publication
(10) Pub. No.: US 2005/0269156 A1
(43) Pub. Date: Dec. 8, 2005

(54) Accessory attachment system for a ladder, and methods

(76) Inventor: Philip F. Lanzafame, Poulsbo, WA (US)

Correspondence Address: Jeffrey T. Haley, Suite. 350, 155-108th Avenue N.E., Bellevue, WA, 98004-5901, US

(21) Appl. No.: 11/142,080

(22) Filed: May 31, 2005

Related U.S. Application Data
(60) Provisional application No. 60/577,048, filed on Jun. 3, 2004.
(60) Provisional application No. 60/588,680, filed on Jul. 15, 2004.

(51) Int. Cl. E06C 7/00

(52) U.S. Cl. 182/129

(57) ABSTRACT

A quick release ladder accessory attachment system is provided. In one embodiment, a ladder system includes a rail having an end and a body, and a ladder-accessory mount operable to releasably attach a ladder accessory to the body of the rail with only one's hand. The ladder-accessory mount includes one or more slots disposed in the body of the rail and operable to receive a corresponding protrusion of a ladder accessory. When coupled, the slots and protrusions restrain movement of the ladder accessory relative to the rail. The slots allow one to quickly attach and release a corresponding protrusion of the ladder accessory, and thus allow quick attachment and release of the ladder accessory to the rail. In another embodiment, a ladder system includes a rail having an end and a body, and an attachment base mounted to the body and operable to releasably attach a ladder accessory to the rail with only one's hand.

### CROSS-REFERENCE TO RELATED APPLICATIONS

The present application claims priority from pending U.S. provisional patent applications, Nos. 60/549,195 and 60/577,048, respectively filed 01 Mar. 2004 and 03 Jun. 2004, and U.S. non-provisional patent application Ser. No. 10/697,674 filed 29 Oct. 2003 and titled QUICK RELEASE FOR LADDER LEVELERS, which is herein incorporated by reference.

### BACKGROUND

Extension ladders, combination ladders, and stepladders consist essentially of two rails with rungs between the rails. Various accessories, for example levelers, wheels, tool or paint can hooks and plank support brackets, can be attached to the ladders to help one work from the ladder. Each of these accessories typically has its own method of attachment to the ladder, for example releasably hooking onto the rungs or securely held to the rails by bolts placed through holes specially drilled into the rails and threaded into a nut or receptacle of the accessory.

For example, for many types of ladders it is useful to have a leveler at the bottom of one leg or both legs. The leveler effectively adjusts the length of the bottom of the leg so that the ladder will go straight up from uneven ground or from different treads in a staircase. For safety, levelers are preferably securely bolted to the rails of the ladder or a static portion of the leveler may be integral with the leg of the ladder.

For ladders that are often used without a leveler, it is undesirable to have the extra weight of the levelers always present. Although levelers have been designed that quickly attach to rungs of a ladder or slip over the bottoms of the rails to achieve a quick attachment and release feature, these attachments are not sufficiently secure and include protrusions that catch on objects, damaging the object or the protrusion or creating a hazard.

### SUMMARY OF THE INVENTION

The invention is a way of attaching a ladder accessory to a ladder so that it can be quickly and securely mounted and released by hand without using tools. In one aspect of the invention, a ladder system includes a rail having an end and a body, and a ladder-accessory mount operable to releasably attach a ladder accessory to the body of the rail with only one's hand. The rail defines six directions that include up and down along the rail, in toward a rung of the ladder and out away from the rung, and left and right perpendicular to the up/down and in/out directions. The ladder accessory mount includes one or more slots disposed in the body of the rail and operable to receive a corresponding protrusion of a ladder accessory. When coupled, the slots and protrusions restrain movement of the ladder accessory relative to the rail in five of the six directions. The slots allow one to quickly attach and release a corresponding protrusion of the ladder accessory, and thus allow quick attachment and release of the ladder accessory to the rail. In some embodiments the weight of the ladder accessory restrains movement of the accessory relative to the rail in the sixth direction. In other embodiments a catchment restrains such movement. In still other embodiments a safety lock restrains such movement.

In another aspect of the invention, a ladder system includes a rail having an end and a body, and an attachment base mounted to the body and operable to releasably attach a ladder accessory to the rail with only one's hand. The attachment base includes a base with a flat ladder rail mating surface, at least 1 inch wide by 8 inches high, with at least two ladder rail attachment points and defines six directions including up and down along the rail mating surface, in toward the rail mating surface and out away from the rail mating surface, and left and right perpendicular to the up/down and in/out directions. The attachment base also includes a ladder-accessory mount operable to releasably attach a ladder accessory to the base with only one's hand, wherein the ladder accessory mount restrains movement of the ladder accessory relative to the base in five of the six directions, and a catchment operable to restrain movement of the ladder accessory relative to the base in the sixth direction until a release is actuated to allow movement in the sixth direction which releases the mating structure.

In yet another aspect of the invention, a releasable ladder-accessory kit for a ladder, includes a ladder accessory having a ladder mount, and an attachment base mountable to a body of a ladder rail and having a ladder-accessory mount operable to releasably attach the ladder accessory to the attachment base with only one's hand.

In still another aspect of the invention, a ladder accessory includes an accessory body, and a ladder mount including at least one slot that receives a protrusion of a body of a ladder rail to releasably attach the ladder accessory to the body of the rail with only one's hand, wherein, when the slot receives the protrusion, the ladder mount defines six directions relative to the ladder rail including up and down along the rail, in toward a rung and out away from the rung, and left and right perpendicular to the up/down and in/out directions, and the slot restrains movement of the ladder mount with respect to the ladder rail in five of the six directions.

In still another aspect of the invention, a ladder accessory includes an accessory body, and a ladder mount including at least one protrusion that mates with a slot of a body of a ladder rail to releasably attach the ladder accessory to the body of the rail with only one's hand.

### BRIEF DESCRIPTION OF THE DRAWINGS

The features of the present invention which are believed to be novel are set forth with particularity in the appended claims. Aspects of the invention may best be understood by making reference to the following description taken in conjunction with the accompanying drawings wherein:

FIG. 1 is an exploded, perspective view of a ladder system that incorporates a ladder accessory releasably attachable to a ladder, according to an embodiment of the invention.

FIG. 2 is a cross-sectional view of the ladder accessory in FIG. 1 releasably attached to the ladder, according to an embodiment of the invention.

FIG. 3 is a partial view of a ladder system that incorporates an attachment base, according to another embodiment of the invention.

FIG. 4 is an exploded, perspective view of the attachment base in FIG. 3, according to an embodiment of the invention.

FIG. 5 is a partial view of the ladder system of FIG. 3 showing a ladder accessory ready to be releasably attached to the attachment base in FIGS. 3 and 4.

FIG. 6 is a partial view of the ladder system of FIG. 5 showing the ladder accessory releasably attached to the attachment base.

FIG. 7 is a perspective view of a ladder platform releasably attached to the ladder in FIG. 1, according to an embodiment of the invention.

FIG. 8 is a perspective view of a different ladder jack, according to another embodiment of the invention.

FIG. 9 is a perspective view of a V-rung and hook releasably attachable to the ladder in FIG. 1, according to another embodiment of the invention.

FIG. 10 is a perspective view of a cinch strap releasably attachable to the ladder in FIG. 1, according to another embodiment of the invention.

FIG. 11 is a perspective view of a carriage releasably attachable to the ladder in FIG. 1, according to another embodiment of the invention.

FIG. 12 is a perspective view of a hook releasably attachable to the ladder in FIG. 1, according to another embodiment of the invention.

FIG. 13 is a perspective view of a different hook releasably attachable to the ladder in FIG. 1, according to another embodiment of the invention.

FIG. 14 is a perspective view of a standout bracket releasably attachable to the ladder in FIG. 1, according to another embodiment of the invention.

FIG. 15 is a perspective view of a stabilizer releasably attachable to the ladder in FIG. 1, according to another embodiment of the invention.

FIG. 16 is a perspective view of a leveler releasably attachable to the ladder in FIG. 1, according to another embodiment of the invention.

### DETAILED DESCRIPTION

In the following detailed description of exemplary embodiments of the invention, reference is made to the accompanying drawings. The detailed description and the drawings illustrate specific exemplary embodiments by which the invention may be practiced. Other embodiments may be utilized, and other changes may be made, without departing from the spirit or scope of the present invention. The following detailed description is therefore not to be taken in a limiting sense, and the scope of the present invention is defined by the stated claims.

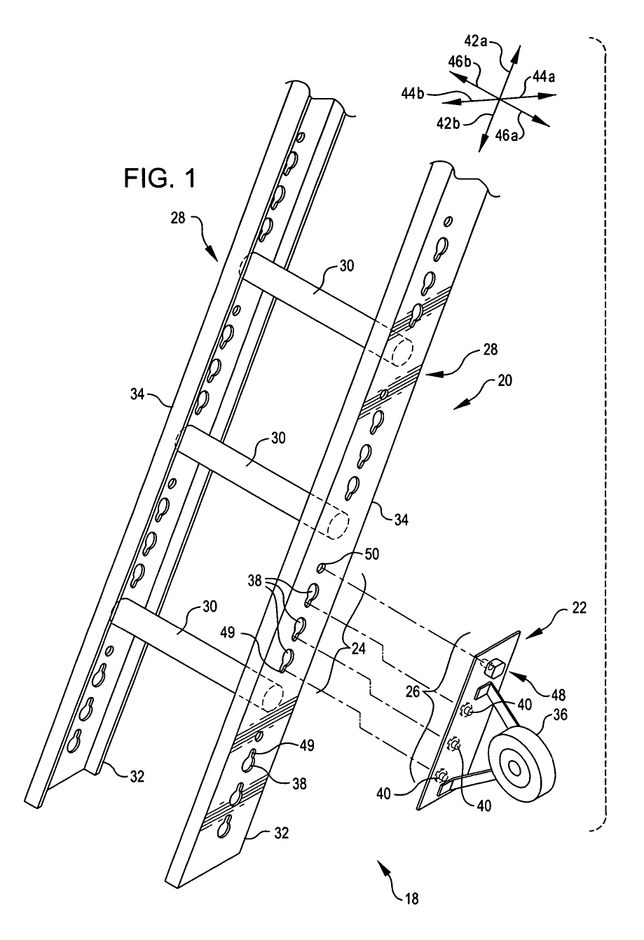

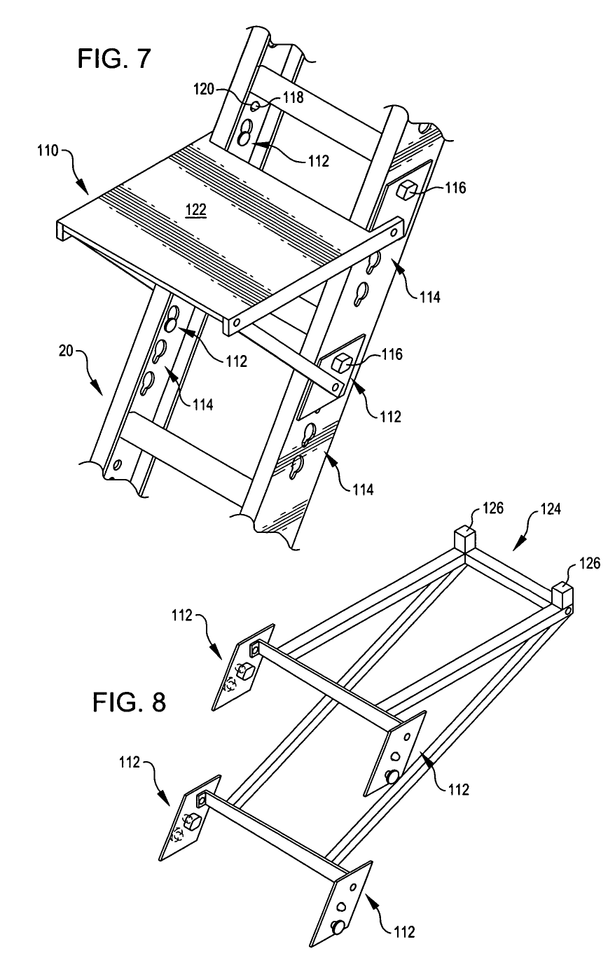

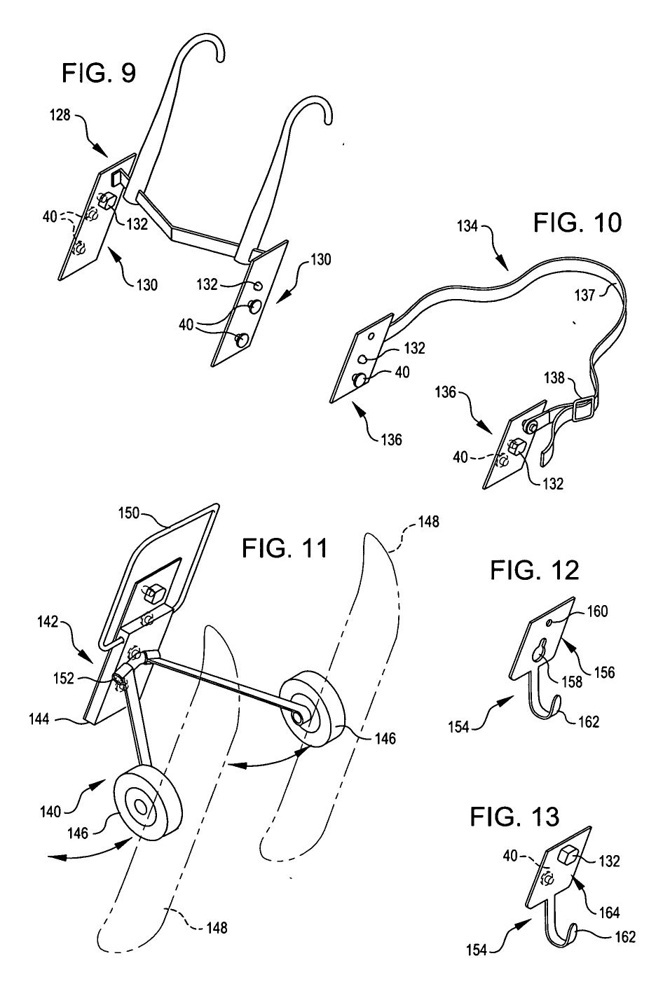

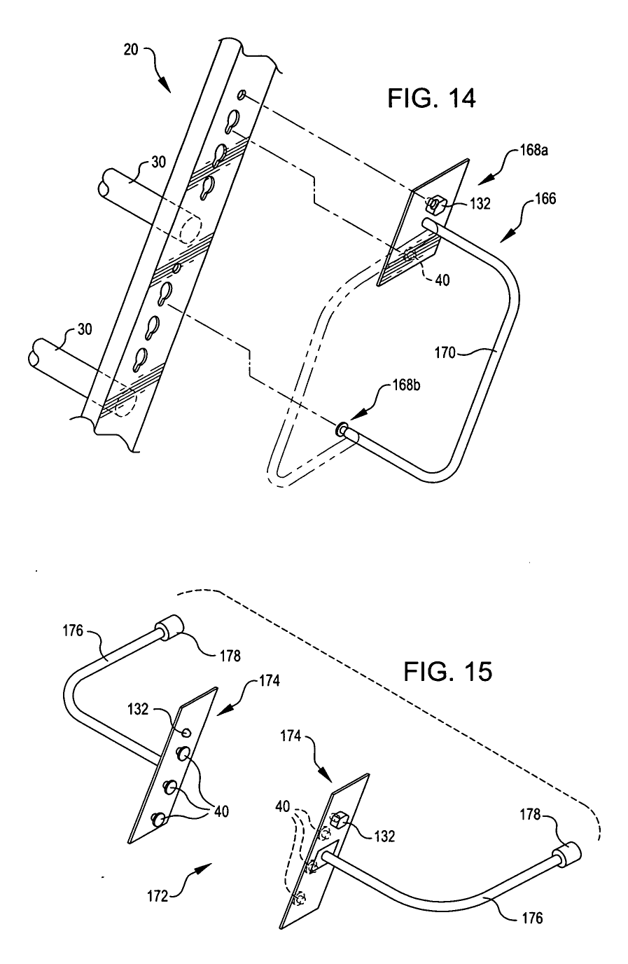

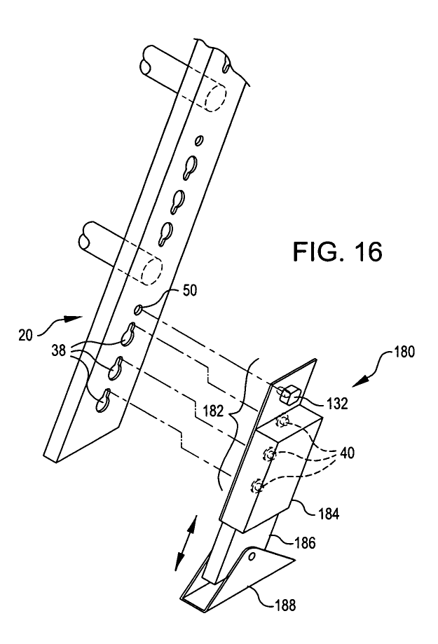

FIG. 1 is an exploded, perspective view of a ladder system 18 according to an embodiment of the invention. The ladder system 18 includes a ladder 20 and a ladder accessory 22 releasably mounted to the ladder 20. The ladder 20 includes a ladder-accessory mount 24 (eight shown but only one indicated with the reference number 24 for clarity), and the ladder accessory 22 includes a ladder mount 26 that one can couple to the ladder-accessory mount 24 to releasably attach the ladder accessory 22 to the ladder 20. The ladder 20 also includes two rails 28 and rungs 30 disposed between and attached to the rails 28. As shown in FIG. 1, each rail 28 includes an end 32 and a body 34, and each body 34 may incorporate a ladder-accessory mount 24. Furthermore, the ladder 20 may include fewer or more ladder-accessory mounts 24 as desired. The ladder accessory 22 includes a wheel 36 for ease of transporting the ladder 20 but may include any other desired structure, such as a ladder platform (discussed in greater detail in conjunction with FIG. 7), a ladder jack (discussed in greater detail in conjunction with FIG. 8), a V-rung and hook (discussed in greater detail in conjunction with FIG. 9), a safety cinch strap (discussed in greater detail in conjunction with FIG. 10), a carriage and ski (discussed in greater detail in conjunction with FIG. 11), a hook (discussed in greater detail in conjunction with FIGS. 12 and 13), a standout bracket (discussed in greater detail in conjunction with FIG. 14), a stabilizer (discussed in greater detail in conjunction with FIG. 15) and a leveler (discussed in greater detail in conjunction with FIG. 16).

The ladder-accessory mount 24 and the ladder mount 26 may be any desired structure that cooperate with each other to releasably attach the ladder accessory 22 to the ladder 20. For example, in one embodiment the ladder-accessory mount 24 may include three slots 38, and the ladder mount 26 may include three protrusions 40 that mate with a respective one of the slots 38 to restrain movement of the ladder accessory 22 relative to the rail 28 in five of six directions 42a, 42b, 44a, 44b, 46a and 46b. The direction 42a is up along the rail 28, and the direction 42b is opposite the direction 42a or down along the rail 28. The direction 44a is perpendicular to the directions 42a and 42b, and right, along the width of the rail 28, and the direction 44b is opposite the direction 42a or left along the width of the rail 28. The direction 46a is perpendicular to the directions 42a, 42b, 44a and 44b, and out away from the rungs 30 of the ladder 20, and the direction 46b is opposite the direction 46a or toward the rungs 30 of the ladder 20.

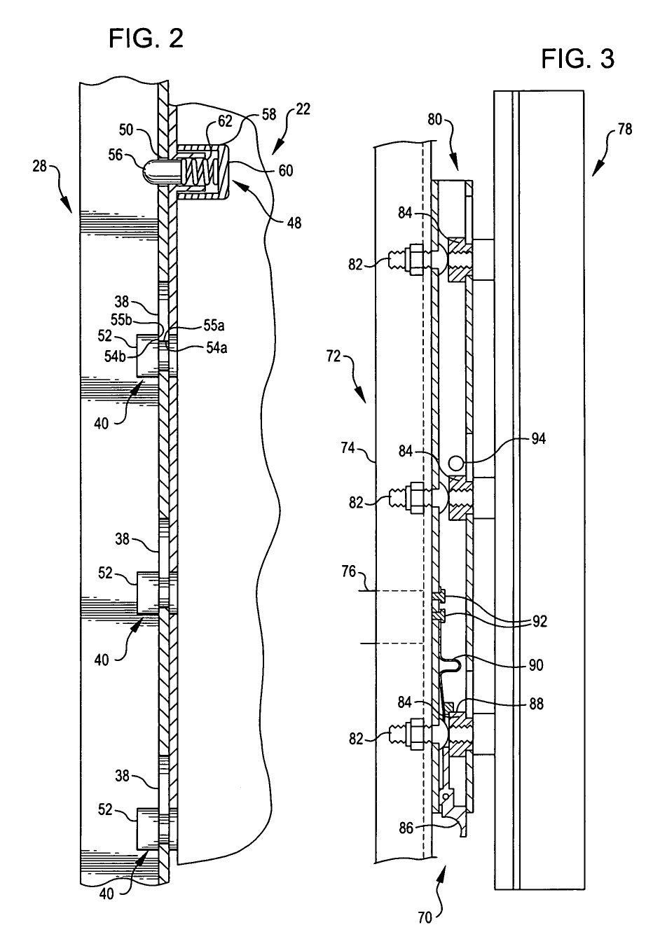

Still referring to FIG. 1, the ladder system 18 may include a safety lock 48 to lock the ladder accessory 22 to the ladder 20. For example, in one embodiment the ladder mount 26 of the ladder accessory 22 includes the safety lock 48. The safety lock 48 includes a locking pin (not shown but discussed in greater detail in conjunction with FIG. 2) that may be inserted into the hole 50 in the rail 28. The safety lock 48 restrains movement of the ladder accessory 22 relative to the rail 28 in the sixth direction (here direction 42a or up) when the ladder accessory 22 is releasably attached to the rail 28. Thus, the safety lock 48 secures the ladder accessory 22 to the ladder 20. In applications when the weight of the ladder accessory 22 or the pressure exerted on the accessory 22 from a tool, material or user supported by the accessory 22 sufficiently restrains the accessory from moving relative to the rail 28 in the sixth direction 42a, the safety lock 48 may be omitted or not used. However, when the safety lock 48 is used in such applications, the safety lock provides additional security against the ladder accessory being accidentally released from the ladder 20.

In operation, one releasably attaches the ladder accessory 22 to the ladder 20 by coupling the ladder mount 26 with the ladder-accessory mount 24. For example, in one embodiment one inserts each protrusion 40 into a respective one of the slots 38. Then one moves each protrusion up or in the direction 42a, or down or in the direction 42b (here down) inside the slot 38 to insert each protrusion 40 into the narrower portion 49 of the respective slot 38. As shown and discussed in greater detail in conjunction with FIG. 2, contact between one or more of the protrusions 40 with the narrower portion 49 of respective slots 38 restrain movement of the ladder accessory 22 relative to the rail 28 in the directions 42b, 44a, 44b, 46a and 46b. With each protrusion 40 inserted in the narrower portion 49 of the respective slot 38, the locking pin of the safety lock 48 is aligned with hole 50 and urged into the hole. To remove the ladder accessory 22 to replace it with another one, one removes the accessory 22 by withdrawing the locking pin from the hole 50, moving each protrusion 40 up or in the direction 42a relative to the rail 28, and withdrawing each protrusion 40 from the respective slot 38.

FIG. 2 is a cross-sectional view of the ladder accessory 22 releasably attached to the ladder 20.

Each protrusion 40 and slot 38 may be configured as desired to restrain movement of the ladder accessory 22 relative to the ladder rail 28 when a protrusion 40 is inserted into a respective one of the slots 38. For example, in one embodiment each protrusion includes a knob 52 and each slot 38 includes a narrower portion 49 (FIG. 1). The knob 52 includes contact surfaces 54a and 54b, and each slot includes contact surfaces 55a and 55b. When a protrusion 40 is inserted into the narrower portion 49 of a respective slot 38 and pressure is exerted on the ladder accessory 22 in one or more of the directions 42b, 44a and 44b, the contact surfaces 54a and 55a contact each other to restrain movement of the ladder accessory 22 relative to the rail 28. And when pressure is exerted on the ladder accessory 22 in the direction 46a, the contact surfaces 54b and 55b contact each other to restrain movement of the ladder accessory 22 relative to the rail 28. Movement of the ladder accessory 22 relative to the rail 28 in the direction 46b is restrained by contact between the rail 28 and the ladder accessory 22. Movement of the ladder accessory 22 relative to the rail 28 in the direction 42a is restrained by the safety lock 48.

Other embodiments are contemplated. For example, the ladder mount 26 may include the slots 38, and the ladder-accessory mount 24 may include the protrusions 40. In addition, the ladder-accessory mount 24 may include more or fewer slots, and the ladder mount 26 may include more or fewer protrusions. In addition, friction between the contact surfaces 54b and 55b may help restrain movement of the ladder accessory 22 relative to the ladder 20. This may be desirable when the safety lock 48 is omitted.

Still referring to FIG. 2, the safety lock 48 may automatically lock the ladder accessory 22 to the ladder 20, when the ladder-accessory mount 24 is coupled to the ladder mount 26. For example, in one embodiment the safety lock 48 includes a locking pin 56 that may be inserted into the hole 50 of the rail 28, a housing 58 attached to the ladder mount 26 and having a wall 60, and a spring 62 to urge the locking pin 56 away from the wall 60. When the locking pin 56 is aligned with the hole 50, the spring 62 urges the locking pin 56 into the hole 50. Thus, when the ladder accessory 22 is moved in the up direction 42a, the rail 28 contacts the locking pin 56 to restrain movement of the ladder accessory 22 in the up direction 42a.

FIG. 3 is a partial view of ladder system 70 according to another embodiment of the invention. The ladder system 70 includes a ladder 72 having a rail 74 and a rung 76, a ladder accessory 78, and an attachment base 80 to releasably attach the ladder accessory 78 to the ladder 72. The attachment base 80, bolts 82 that secure the attachment base to the ladder rail, and knobs 84 that protrude from the ladder accessory 78 and mate with the attachment base 80 are all shown in cross-section. Also shown is a spring latch 86 that catches on a catch surface 88 on one of the knobs 84. The latch 86 is held in a position engaging the catch surface 88 by a spring 90, which is held in place by two rivets 92. The cross-sectional view also shows the shaft of a locking pin 94 which may be inserted to insure safety. The locking pin 94 may be a ring pin.

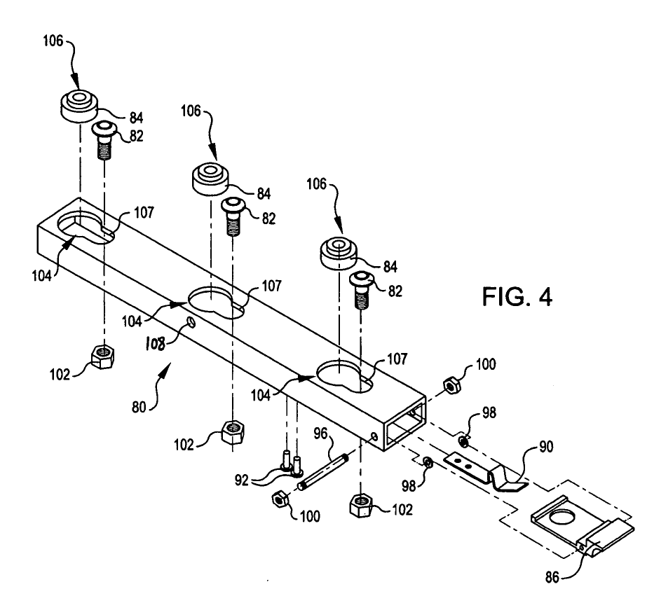

FIG. 4 is an exploded perspective view of the attachment base 80 according to an embodiment of the invention. FIG. 4 shows the parts identified in the previous paragraph and, in addition shows a hinge pin 96 that passes through the base 80, the spring latch 86, two washers 98, and a nut 100 on each end to retain the pin 96. FIG. 4 also shows the nuts 102 that secure the attachment base 80 to the ladder rail 74 using the attachment bolts 82. FIG. 4 further shows the ladder-accessory mount 104 that engages a ladder mount 106. In the embodiment shown in FIG. 4, the ladder-accessory mount 104 includes a keyhole slot 107, the ladder mount 106 includes a knob 84, and the design includes three pairs of keyhole slots 107 and knobs 84. In addition, the attachment base 80 includes a hole 108 for receiving the locking pin 94 (FIG. 3). Any of many alternative structures for releasably attaching the ladder accessory 78 to the attachment base 80 could be used. For example, slots like those shown in FIG. 4 could be on the ladder accessory 78 and knobs like those shown in FIG. 4 could be on the attachment base 80. In addition, the structure of the attachment base 80 can be integrated with the rail 74 of the ladder 72.

The dimensions of the attachment base 80 should be at least one inch by eight inches to insure adequate rigidity in its connection to the ladder rail and to the leveler. In one embodiment, the dimensions of the attachment base are one and one-half inch by 12 inches. The attachment base need be only as thick as necessary to perform all of its functions. In one embodiment made of 6063-T52 aluminum rectangular tubing with one-eighth inch wall thickness, the base is three-quarters inch thick in the smallest dimension of the base.

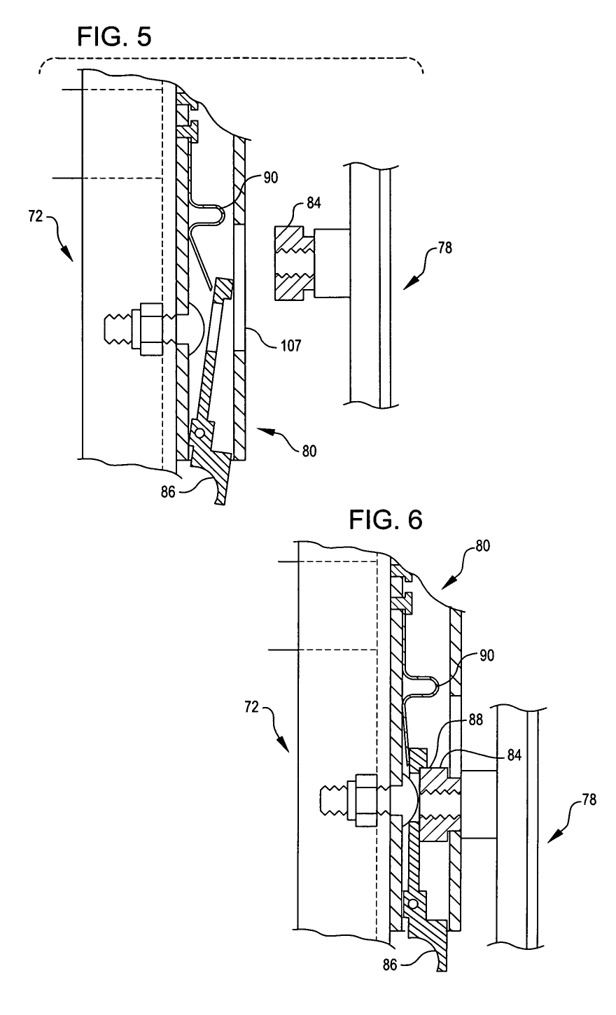

FIG. 5 shows a section view of a knob 84 ready for insertion into a slot 107. The spring 90 holds the latch 86 against the slot 107. FIG. 6 shows the knob 86 in the latched position. The spring 90 holds the latch 86 into a position that catches the catch surface 88 of the knob 84.

FIG. 7 is perspective view of a ladder platform 110 releasably attached to the ladder 20 in FIG. 1, according to an embodiment of the invention. In one embodiment, the ladder platform 110 includes four ladder mounts 112 (two partially shown) that are each coupled to a ladder-accessory mount 114. Each ladder mount 112 includes a safety lock 116 that includes a locking pin 118 (only one shown for clarity) inserted into a hole 120 (only one shown for clarity) to lock the ladder platform 110 to the ladder 20. The ladder platform 110 also includes a platform 122 that one may use to support anything as desired such as a tool, a bucket, or oneself.

FIG. 8 is a perspective view of a ladder jack 124 that may be releasably attached to the ladder 20 (FIG. 1). The ladder jack 124 includes two retainers 126 that help retain lumber, pipe, and any other desired items to the ladder jack 124. When two ladder jacks 124 are releasably attached to a respective one of two ladders 20 disposed substantially parallel to each other, the ladder jacks 124 may be used to support long boards of lumber close to a desired location on a building that requires repair, and/or to support a platform (not shown) to form a scaffold that one may use to traverse between the ladders 20.

FIG. 9 is a perspective view of a V-rung and hook 128 according to an embodiment of the invention. The V-rung and hook 128 may be releasably fastened to the ladder 20 (FIG. 1) to stabilize the ladder when a round pole, such as a telephone pole, supports the ladder. In one embodiment, the V-rung and hook 128 include two ladder mounts 130, each including two protrusions 40 and one safety lock 132.

FIG. 10 is a perspective view of a cinch strap 134 according to an embodiment of the invention. The cinch strap 134 may be releasably fastened to the ladder 20 (FIG. 1) to also stabilize the ladder 20. In one embodiment, the cinch strap 134 includes two ladder mounts 136, each mount including one protrusion 40 and one safety lock 132. The cinch strap 134 also includes a strap 137 for wrapping around a structure, such as a pole (not shown), or for inserting through a structure, such as a loop, eyelet, or hook, to hold the ladder 20 to the structure. The strap 137 may also include a buckle 138 to allow one to adjust the length of the strap 137 to fit different sized structures or structures located different distances away from the ladder 20.

FIG. 11 is a perspective view of a carriage 140 according to an embodiment of the invention. The carriage 140 may be releasably fastened to the ladder 20 (FIG. 1) to support the ladder 20 as one transports the ladder 20. In one embodiment, the carriage 140 includes one ladder mount 142 that includes three protrusions 40 and a safety lock 132. The carriage 140 includes a body 144, two wheels 146 (and/or two skis 148 shown in phantom), and a handle 150 that one may use to extend and retract the wheels 146 relative to the body 144. The carriage 140 also includes a hub 152 that pivotally attaches the wheels 146 to the body 144 and secures the wheels 146 in an extended and retracted position.

FIGS. 12 and 13 are perspective views of a hook 154 according to embodiments of the invention. The hook 154 may be releasably attached to the ladder 20 (FIG. 1) to provide a structure that one can use to suspend things, such as tools and/or materials. In one embodiment, the hook 154 includes one ladder mount 156 that includes a slot 158 to receive a protrusion (not shown) of a ladder's ladder-accessory mount (not shown), and a hole 160 to receive a locking pin (not shown) of a safety lock (not shown) mounted to the ladder 20. The hook 154 also includes a curved end 162 to support the things desired. In other embodiments, the hook 154 includes one ladder mount 164 that includes a protrusion 40 and a safety lock 132.

FIG. 14 is a perspective view of a standout bracket 166 according to an embodiment of the invention. The standout bracket 166 may be releasably attached to the ladder 20 to support the ladder 20 away from a surface of a structure such as a building. In one embodiment, the standout bracket 166 includes two ladder mounts 168a and 168b. The mount 168a includes a protrusion 40 and a safety lock 132, and the mount 168b includes a protrusion 40. The standout bracket 166 also includes a bar 170 that may extend away from the rungs 30, perpendicular to the rungs 30 or any other desired direction.

FIG. 15 is a perspective view of a stabilizer 172 according to an embodiment of the invention. The stabilizer 172 may be releasably attached to the ladder 20 (FIG. 1) to help stabilize the ladder 20 when the ladder 20 is supported by a structure such as a flat, vertical wall (not shown). In one embodiment, the stabilizer 172 includes two ladder mounts 174, each including three protrusions 40 and a safety lock 132. The stabilizer 172 also includes a bar 176 having an end 178 that contact the structure supporting the ladder 20 and thus provides a wider footprint.

FIG. 16 is a perspective view of a leveler 180 according to an embodiment of the invention. The leveler 180 may be releasably attached to the ladder 20 to level the ladder 20 when the ladder 20 is supported by an uneven structure such a steps of a stair way or uneven ground. In one embodiment, the leveler 180 includes one ladder mount 182 that includes three protrusions 40 and a safety lock 132. The leveler 180 also includes a body 184, a support 186 extendable and retractable relative to the body 184, and foot 188 that contacts the structure supporting the ladder 20.

Although the present invention has been described in considerable detail with reference to certain embodiments, other embodiments are possible. Therefore, the spirit or scope of the appended claims should not be limited to the description of the embodiments contained herein. It is intended that the invention resides in the claims hereinafter appended.

1. An attachment base for a ladder, comprising:
a base with a flat ladder rail mating surface, at least 1 inch wide by 8 inches high, with at least two ladder rail attachment points;
the base defining six directions including up and down along the rail mating surface, in toward the rail mating surface and out away from the rail mating surface, and left and right perpendicular to the up/down and in/out directions;
a ladder-accessory mount operable to releasably attach a ladder accessory to the base with only one's hand, wherein the ladder accessory mount restrains movement of the ladder accessory relative to the base in five of the six directions; and
a catchment operable to restrain movement of the ladder accessory relative to the base in the sixth direction until a release is actuated to allow movement in the sixth direction which releases the mating structure.

2. The attachment base of claim 1 wherein the sixth direction is down.

3. The attachment base of claim 1 wherein the sixth direction is one of left or right.

4. The attachment base of claim 1 wherein the sixth direction is one of up or out.

5. The attachment base of claim 1 wherein the catchment includes a retained, hand-movable latch on the base.

6. The attachment base of claim 1 wherein the catchment includes a surface that catches a movable latch on the ladder accessory.

7. The attachment base of claim 1 wherein the ladder-accessory mount comprises at least one slot that receives a mating structure of the ladder accessory.

8. The attachment base of claim 1 wherein the ladder-accessory mount comprises at least one protrusion that mates with a mating structure of the ladder accessory.

9. The attachment base of claim 8 wherein the protrusion includes a knob.

10. The attachment base of claim 1 further comprising a safety lock that locks the ladder accessory to the attachment base.

11. The attachment base of claim 10 wherein the safety lock includes a locking pin insertable into a hole in the base.

12. The attachment base of claim 10 wherein the safety lock is mounted to the ladder accessory and includes a locking pin insertable through a hole in the base, and a spring to urge the locking pin into the hole in the base when the locking pin is adjacent to and aligned with the hole.

13. A ladder system comprising:
a rail having an end and a body; and
an attachment base mounted to the body and operable to attach a ladder accessory to the rail, the attachment base including:
a base with a flat ladder rail mating surface, at least 1 inch wide by 8 inches high, with at least two ladder rail attachment points;
the base defining six directions including up and down along the rail mating surface, in toward the rail mating surface and out away from the rail mating surface, and left and right perpendicular to the up/down and in/out directions;
a ladder-accessory mount operable to releasably attach a ladder accessory to the base with only one's hand, wherein the ladder accessory mount restrains movement of the ladder accessory relative to the base in five of the six directions; and
a catchment operable to restrain movement of the ladder accessory relative to the base in the sixth direction until a release is actuated to allow movement in the sixth direction which releases the mating structure.

14. The ladder system of claim 13 wherein the attachment base includes a safety lock that locks the ladder accessory to the attachment base.

15. The ladder system of claim 13 wherein the safety lock includes a locking pin.

16. The ladder system of claim 13 wherein the ladder accessory includes at least one of the following, a leveler, a wheel, a ski, a V-rung and hook, a stabilizer, a standout bracket, a hook, a ladder jack, a ladder platform, a tool tray, a safety cinch strap.

17. A ladder system comprising:
a rail defining six directions including up and down along the rail, in toward a rung of the ladder and out away from the rung, and left and right perpendicular to the up/down and in/out directions, and having an end and a body; and
a ladder-accessory mount operable to releasably attach a ladder accessory to the body of the rail with only one's hand.

18. The ladder system of claim 17 wherein the ladder-accessory mount includes one or more slots disposed in the body of the rail and operable to receive the ladder accessory.

19. The ladder system of claim 18 wherein the ladder-accessory mount restrains movement of the ladder accessory relative to the rail in five of the six directions.

20. The ladder system of claim 19 wherein the sixth direction is up.

21-67. (canceled)
